(19) United States
(12) Patent Application Publication
(10) Pub. No.: US 2015/0140988 A1
(43) Pub. Date: May 21, 2015

(54) METHOD OF PROCESSING EVENT AND ELECTRONIC DEVICE THEREOF

(71) Applicant: Samsung Electronics Co., Ltd., Gyeonggi-do (KR)

(72) Inventors: Seung-Nyun Kim, Incheon (KR); Hun-Cheol Oh, Seoul (KR); Deog-Moh Chang, Gyeonggi-do (KR); Doo-Suk Kang, Gyeonggi-do (KR)

(21) Appl. No.: 14/548,096

(22) Filed: Nov. 19, 2014

(30) Foreign Application Priority Data
Nov. 19, 2013 (KR) 10-2013-0140775

(51) Int. Cl. H04M 1/725; H04W 4/18

(52) U.S. Cl. CPC H04M 1/72575; H04W 4/18
USPC 455/418

(57) ABSTRACT

A device and method in which an electronic device processes an event by interlocking with another electronic device are provided. The method of operating an electronic device includes detecting occurrence of an event. The method also includes determining state information of the electronic device. The method further includes determining whether to interlock event information with at least one second electronic device based on the state information of the electronic device. The method includes transmitting event information to the at least one second electronic device in response to event information interlocking determination with the at least one second electronic device.

### PRIORITY

The present application is related to and claims the benefit under 35 U.S.C. §119(a) of a Korean patent application filed in the Korean Intellectual Property Office on Nov. 19, 2013 and assigned Serial No. 10-2013-0140775, the entire disclosure of which is hereby incorporated by reference.

### TECHNICAL FIELD

The present disclosure relates to a device and method in which an electronic device processes an event by interlocking with another electronic device.

### BACKGROUND

With the development of information and communication technology and semiconductor technology, various electronic devices have been developed into a multimedia device that provides various multimedia services. For example, an electronic device provides various multimedia services such as a messenger service, a broadcasting service, a wireless Internet service, a camera service, and a music reproduction service.

However, a user of the electronic device requires more various services. Accordingly, the electronic device requires a service for satisfying various desires of the user.

### SUMMARY

To address the above-discussed deficiencies, it is a primary object to provide a device and method in which an electronic device processes an event by interlocking with another electronic device.

Another aspect of the present disclosure is to provide a device and method in which an electronic device processes an event by interlocking with another electronic device based on state information thereof.

Another aspect of the present disclosure is to provide a device and method in which an electronic device processes an event by interlocking with another electronic device based on at least one of state information of the another electronic device, an event characteristic, and state information of the electronic device.

In a first example, a method of operating an electronic device is provided. The method includes detecting occurrence of an event. The method also includes determining state information of the electronic device. The method further includes determining whether to interlock event information with at least one second electronic device based on the state information of the electronic device. The method includes transmitting event information to the at least one second electronic device in response to event information interlocking determination with the at least one second electronic device.

In a second example, an electronic device is provided. The electronic device includes a communication unit. The electronic device also includes a sensor module. The electronic device further includes a processor configured to determine whether to interlock event information with at least one second electronic device based on determined state information of the electronic device using the sensor module in response to an event occurrence and transmit event information to the at least one second electronic device through the communication unit in response to the event information interlocking determination.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating an example structure for connecting an electronic device to another electronic device through a wire link according to this disclosure;

FIG. 2 is a diagram illustrating an example structure for connecting an electronic device to another electronic device through a wireless link according to this disclosure;

FIG. 3 is a block diagram illustrating an example configuration of an electronic device according to this disclosure;

FIG. 4 is a block diagram illustrating an example configuration of a processor according to this disclosure;

FIG. 5 is a block diagram illustrating an example configuration of an electronic device according to this disclosure;

FIG. 6 is a flowchart illustrating an example procedure in which an electronic device transmits event information to another electronic device according to this disclosure;

FIG. 7 is a flowchart illustrating an example procedure in which an electronic device transmits event information to another electronic device based on state information of the electronic device according to this disclosure;

FIG. 8 is a flowchart illustrating an example procedure in which an electronic device transmits event information to another electronic device based on state information of the electronic device according to this disclosure;

FIG. 9 is a flowchart illustrating an example procedure in which an electronic device sets a communication link to another electronic device for interlocking event information according to this disclosure;

FIG. 10 is a flowchart illustrating an example procedure in which an electronic device processes an event received from another electronic device according to this disclosure;

FIG. 11 is a flowchart illustrating an example procedure in which an electronic device processes an event received from another electronic device according to this disclosure;

FIG. 12 is a flowchart illustrating an example procedure in which an electronic device processes an event received from another electronic device based on state information of the electronic device according to this disclosure;

FIG. 13 is a flowchart illustrating an example procedure in which an electronic device transmits event information to another electronic device based on state information of the another electronic device according to this disclosure;

FIG. 14 is a flowchart illustrating an example procedure in which an electronic device processes an event received from another electronic device based on state information of the electronic device according to this disclosure; and

FIGS. 15A, 15B, 15C, 15D, and 15E are diagrams illustrating example screen configurations in which an electronic device processes an event received from another electronic device according to this disclosure.

### DETAILED DESCRIPTION

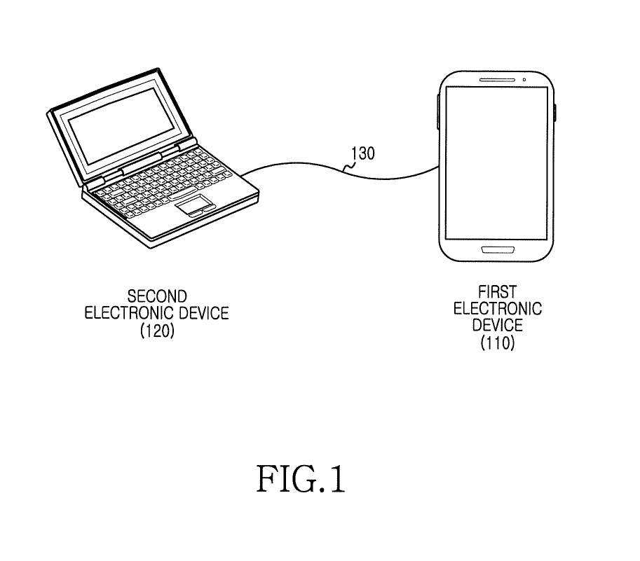

FIGS. 1 through 15E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, various exemplary embodiments of the present disclosure will be described in detail with reference to the drawings. However, it should be understood that various exemplary embodiments of the present disclosure are not limited to a specific exemplary embodiment, but include various modifications, equivalents and/or alternatives of various exemplary embodiments. The same reference numbers are used throughout the drawings to refer to the same or like parts.

In the present disclosure, an expression such as “having,” “may have,” “comprising,” or “may comprise” indicates existence of a corresponding characteristic (such as an element such as a numerical value, function, operation, or component) and does not exclude existence of additional characteristic.

In the present disclosure, an expression such as “A or B,” “at least one of A or/and B,” or “one or more of A or/and B” may include all possible combinations of together listed items. For example, “A or B,” “at least one of A and B,” or “one or more of A or B” may indicate the entire of (1) a case of including at least one A, (2) a case of including at least one B, or (3) a case of including both at least one A and at least one B.

Expressions such as “first,” “second,” “primarily,” or “secondary” used in various exemplary embodiments may represent various elements regardless of order and/or importance and do not limit corresponding elements. The expression may be used for distinguishing one element from another element. For example, a first user device and a second user device may represent different user devices regardless of order or importance. For example, a first element may be referred to as a second element without deviating from the scope of the present disclosure, and similarly, a second element may be referred to as a first element.

When it is described that an element (such as a first element) is “operatively or communicatively coupled to” or “connected to” another element (such as a second element), the element may be directly connected to the other element or may be connected to the other element through a third element. However, when it is described that an element (such as a first element) is “directly connected” or “directly coupled” to another element (such as a second element), it means that there is no intermediate element (such as a third element) between the element and the other element.

An expression “configured to (or set)” used in the present disclosure may be replaced with, for example, “suitable for,” “having the capacity to,” “designed to,” “adapted to,” “made to,” or “capable of ” according to a situation. A term “configured to (or set)” does not always mean only “specifically designed to” by hardware. Alternatively, in some situation, an expression “apparatus configured to” may mean that the apparatus “can” operate together with another apparatus or component. For example, a phrase “a processor configured (or set) to perform A, B, and C” may be a generic-purpose processor (such as a CPU or an application processor) that can perform a corresponding operation by executing at least one software program stored at an exclusive processor (such as an embedded processor) for performing a corresponding operation or at a memory device.

Terms used in the present disclosure are used for only describing a specific exemplary embodiment and may not have an intention to limit the scope of other exemplary embodiments. In the present disclosure and the appended claims, a singular form may include a plurality of forms unless it is explicitly differently represented. Unless differently defined, entire terms including a technical term and a scientific term used here may have the same meaning as a meaning that may be generally understood by a person of common skill in the art. It may be analyzed that generally using terms defined in a dictionary have the same meaning or a meaning similar to that of a context of related technology and are not analyzed as an ideal or excessively formal meaning unless explicitly defined in the present disclosure. In some case, terms defined in the present disclosure cannot be analyzed to exclude exemplary embodiments of the present disclosure.

An electronic device according to various exemplary embodiments of the present disclosure can include, for example, at least one of a smart phone, a tablet Personal Computer (PC), a mobile phone, a video phone, an e-book reader, a desktop PC, a laptop PC, a Netbook computer, a workstation, a sever, a Personal Digital Assistant (PDA), a Portable Multimedia Player (PMP), an MPEG 3 (MP3) player, a mobile medical equipment, a camera, or a wearable device (such as smart glasses, a Head-Mounted-Device (HMD)), electronic clothing, an electronic bracelet, an electronic necklace, electronic accessory, electronic tattoo, or a smart watch.

According to various exemplary embodiments, the electronic device can be a smart home appliance. The smart home appliance can include at least one of, for example, a television, a Digital Video Disk (DVD) player, an audio device, a refrigerator, an air-conditioner, a cleaner, an oven, a microwave oven, a washing machine, an air cleaner, a set-top box, a home automation control panel, a security control panel, a TV box (such as Samsung HomeSync™, Apple TV™, or Google TV™), a game console (such as Xbox™, PlayStation™), an electronic dictionary, an electronic key, a camcorder, a smart mirror, or an electronic frame.

In another exemplary embodiment, the electronic device can include at least one of various medical devices (such as various portable medical measuring device (a blood sugar measuring device, a heartbeat measuring device, a blood pressure measuring device, or a body temperature measuring device), a Magnetic Resonance Angiography (MRA) device, a Magnetic Resonance Imaging (MRI) device, a Computed Tomography (CT) device, a scanning machine, and an ultrasonic wave device), a navigation device, a Global Positioning System (GPS) receiver, an Event Data Recorder (EDR), a Flight Data recorder (FDR), a vehicle infotainment device, an electronic equipment for ship (such as a navigation device for ship and gyro compass), avionics, a security device, a head unit for a vehicle, an industrial or home robot, an Automatic Teller's Machine (ATM) of a financial institution, a point of sales (POS) of a store, or Internet of things (such as a bulb, various sensors, an electric or gas meter, a sprinkler device, a fire alarm, a thermostat, a street light, a toaster, a sports equipment, a hot water tank, a heater, and a boiler).

According to an exemplary embodiment, the electronic device can include at least one of a portion of furniture or building/construction, an electronic board, an electronic signature receiving device, a projector, or various measuring devices (such as water supply, electricity, gas, or electric wave measuring device). According to various exemplary embodiments, an electronic device is at least one combination of the foregoing various devices. An electronic device according to an exemplary embodiment is a flexible electronic device. Further, an electronic device according to an exemplary embodiment of the present disclosure is not limited to the foregoing devices and includes a new electronic device according to technical development.

Hereinafter, an electronic device according to various exemplary embodiments of the present disclosure will be described with reference to the accompanying drawings. In the present disclosure, a term of a user indicates a person using an electronic device or a device (such as artificial intelligence electronic device) using an electronic device.

Hereinafter, in an exemplary embodiment of the present disclosure, technology in which an electronic device processes an event by interlocking with another electronic device will be described.

FIG. 1 is a diagram illustrating an example structure for connecting an electronic device to another electronic device through a wire link according to this disclosure.

Referring to FIG. 1, a first electronic device 110 connects a communication link to a second electronic device 120 using a wire link 130. For example, the first electronic device 110 connects a communication link to the second electronic device 120 using a Universal Serial Bus (USB) cable. For another example, the first electronic device 110 connects a communication link to the second electronic device 120 through a dock connected to the second electronic device 120.

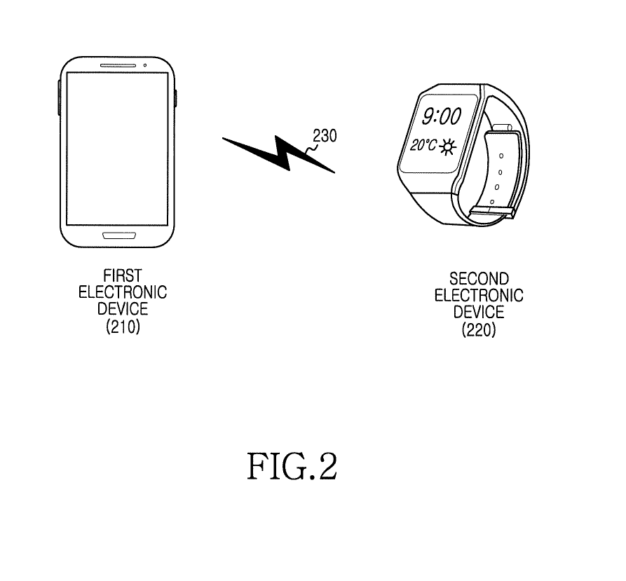

FIG. 2 is a diagram illustrating an example structure for connecting an electronic device to another electronic device through a wireless link according to this disclosure.

Referring to FIG. 2, a first electronic device 210 connects a communication link to a second electronic device 220 using a wireless link 230. For example, the first electronic device 210 connects a communication link to the second electronic device 220 using a short range communication method. Here, the second electronic device 220 includes a wearable electronic device.

As described above, when a communication link (such as a wire link or a wireless link) of the first electronic devices 110 and 210 and the second electronic devices 120 and 220 is connected, any one of the first electronic device 110 and 210 and the second electronic devices 120 and 220 processes an event by interlocking with another electronic device based on at least one of an event characteristic, state information of the electronic device, and state information of the another electronic device. For example, an event characteristic includes at least one of an event kind and a kind of an application program while executing in the electronic device when an event occurs. For example, state information of the electronic device and state information of another electronic device includes at least one of user movement information, a battery residual quantity, and an application program processing load. For example, the user movement information includes information about whether a user determines display information displayed in a display unit of the electronic device.

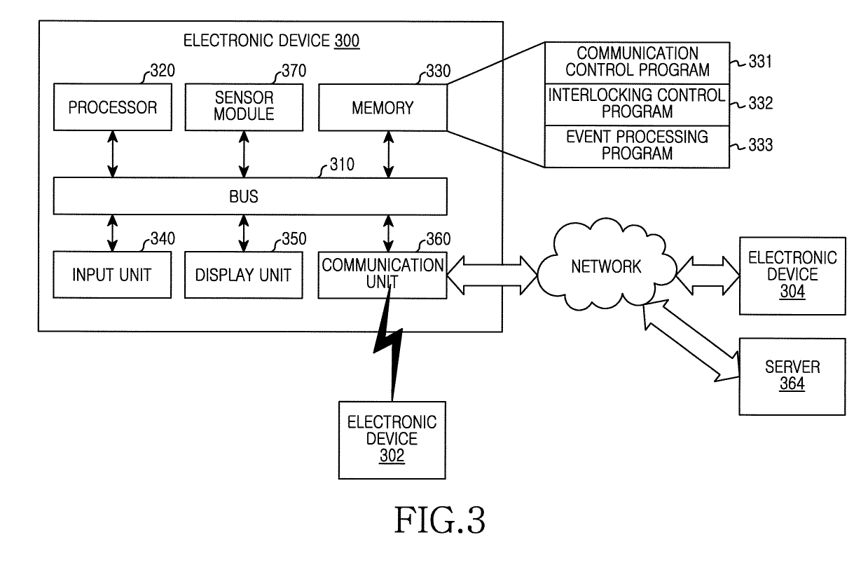

FIG. 3 is a block diagram illustrating an example configuration of an electronic device according to this disclosure.

Referring to FIG. 3, an electronic device 300 includes a bus 310, a processor 320, a memory 330, an input unit 340, a display unit 350, a communication unit 360, and a sensor module 370. Here, at least one of the processor 320 and the memory 330 can exist in plural.

The bus 310 connects elements included in the electronic device 300 and control communication between elements included in the electronic device 300.

The processor 320 controls the electronic device 300 to provide various services. For example, the processor 320 decodes an instruction received from at least one another element (such as the memory 330, the input unit 340, the display unit 350, the communication unit 360, and the sensor module 370) included in the electronic device 300 through the bus 310 and execute a calculation or a data processing according to the decoded instruction.

By executing at least one program stored at the memory 330, the processor 320 controls the electronic device 300 to provide various services.

By executing an interlocking control program 332 stored at the memory 330, the processor 320 controls to transmit event information to another electronic device to which a communication link is connected through the communication unit 360. For example, when an event occurs, the processor 320 determines whether to interlock event processing with another electronic device based on state information of the electronic device 300. When it is determined to interlock event processing with another electronic device, the processor 320 controls to transmit event information to another electronic device to which a communication link is connected. For example, when it is determined to interlock event processing with another electronic device, the processor 320 controls to connect a communication link to another electronic device to transmit event information.

For another example, when an event occurs, the processor 320 determines whether to interlock event processing with another electronic device based on state information of the electronic device 300 and an event characteristic. When it is determined to interlock event processing with another electronic device, the processor 320 controls to transmit event information to which a communication link is connected to another electronic device. For example, when it is determined to interlock event processing with another electronic device, the processor 320 controls to connect a communication link to another electronic device to transmit the event information.

For another example, when an event occurs, the processor 320 determines whether to interlock event processing with another electronic device based on at least one of an event characteristic and state information of another electronic device (such as another electronic device 302 or 304). When it is determined to interlock event processing with another electronic device, the processor 320 transmits a state information request message to another electronic device through the communication unit 360, and determine state information of another electronic device. Thereafter, when another electronic device processes an event, the processor 320 controls to transmit event information to another electronic device through the communication unit 360. For example, when it is determined to interlock event processing with another electronic device, the processor 320 controls to connect a communication link to another electronic device to transmit the event information.

By executing an event processing program 333 stored at the memory 330, the processor 320 controls to process an event that has occurred in the electronic device 300 or another electronic device to which a communication link is connected. For example, when the processor 320 determines not to interlock event processing with another electronic device using the interlocking control program 332, the processor 320 processes an event that has occurred in the electronic device 300.

For another example, when receiving event information from the another electronic device through the communication unit 360, the processor 320 processes an event that has occurred in another electronic device based on event information received from the another electronic device.

For another example, when the processor 320 receives event information from another electronic device through the communication unit 360, the processor 320 determines whether to interlock an event processing with another electronic device based on state information of the electronic device 300. When it is determined to interlock an event processing with another electronic device, the processor 320 processes an event that has occurred in another electronic device based on event information received from the another electronic device.

For another example, when the processor 320 receives event information from another electronic device through the communication unit 360, the processor 320 displays event information received from the another electronic device in the display unit 350. Thereafter, when it is determined to interlock an event processing with another electronic device based on input information received through the input unit 340, the processor 320 processes an event that has occurred in another electronic device based on event information received from the another electronic device.

The memory 330 stores an instruction or data received from at least one element (the processor 320, the input unit 340, the display unit 350, and the communication unit 360) included in the electronic device 300 or generated by at least one element.

The memory 330 stores at least one program for a service of the electronic device 300. For example, the memory 330 includes at least one of a communication control program 331, an interlocking control program 332, and an event processing program 333.

The communication control program 331 includes at least one software component for connecting communication with another electronic device through the communication unit 360.

The interlocking control program 332 includes at least one software component for controlling to transmit event information that has occurred in the electronic device 300 to another electronic device to which a communication link is connected through the communication unit 360.

The event processing program 333 includes at least one software component for controlling to process an event that has occurred in the electronic device 300 or another electronic device to which a communication link is connected.

The input unit 340 transmits an instruction or data occurring by a user selection to the processor 320 or the memory 330 through the bus 310. For example, the input unit 340 includes at least one of a keypad including at least one hardware button and a touch panel that detects touch information.

The display unit 350 displays a picture, an image, or data to the user. For example, the display unit 350 displays application program information driven by the processor 320.

The communication unit 360 connects communication between the electronic device 300 and at least another electronic device 302 or 304, a server 364, or at least one peripheral device. For example, the communication unit 360 supports a short range communication protocol (such as Wireless Fidelity (WiFi), Bluetooth (BT), Near Field Communication (NFC)), a network communication protocol (such as Internet, a Local Area Network (LAN), a Wide Area Network (WAN), a telecommunication network, a cellular network, a satellite network, or a Plain Old Telephone Service (POTS)), or a wire communication protocol (such as a Universal Serial Bus (USB), a High Definition Multimedia Interface (HDMI)). In this case, a communication protocol (such as a short range communication protocol, a network communication protocol, or a wire communication protocol) is supported in middleware or an Application Programming Interface (API) of the memory 330.

The sensor module 370 measures a physical quantity or detects an operation state of an electronic device and convert measured or detected information to an electrical signal. For example, the sensor module 370 estimates a user movement of the electronic device 300 using at least one of a gesture sensor, a gyro sensor, an acceleration sensor, a grip sensor, a proximity sensor, and an illumination sensor.

In the foregoing exemplary embodiment, by interlocking with another electronic device by executing a software component stored at the memory 330 within one module, the processor 320 processes an event.

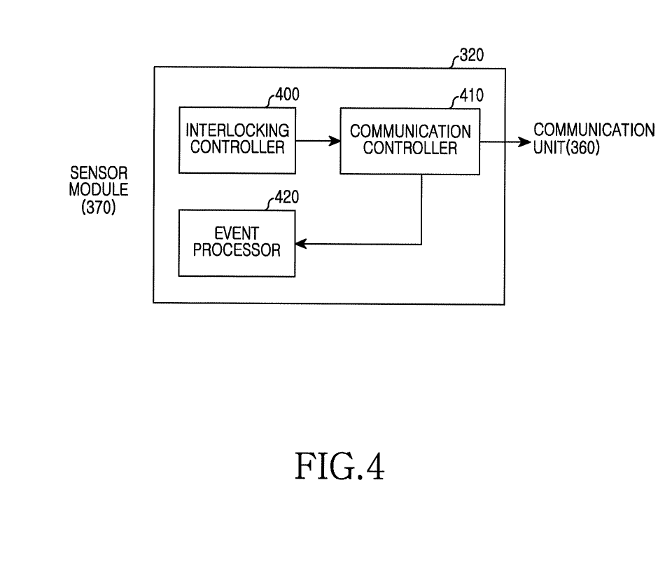

In another exemplary embodiment, as shown in FIG. 4, the processor 320 includes an element for processing an event by interlocking with another electronic device as separate modules.

FIG. 4 is a block diagram illustrating an example configuration of a processor according to this disclosure.

Referring to FIG. 4, the processor 320 includes an interlocking controller 400, a communication controller 410, and an event processor 420.

The interlocking controller 400 controls to transmit event information to another electronic device to which a communication link is connected through the communication unit 360. In this case, by executing the interlocking control program 332 stored at the memory 330, the interlocking controller 400 controls to transmit event information to another electronic device to which a communication link is connected through the communication unit 360. For example, when an event occurs, the interlocking controller 400 determines whether to interlock event processing with another electronic device based on state information of the electronic device 300. When it is determined to interlock event processing with another electronic device, the interlocking controller 400 controls to transmit event information to another electronic device to which a communication link is connected. For example, after it is determined to interlock event processing with another electronic device, the interlocking controller 400 controls to connect a communication link to another electronic device to transmit the event information.

For another example, when an event occurs, the interlocking controller 400 determines whether to interlock event processing with another electronic device based on an event characteristic and state information of the electronic device 300. When it is determined to interlock event processing with another electronic device, the interlocking controller 400 controls to transmit event information to which a communication link is connected to another electronic device. For example, when it is determined to interlock event processing with another electronic device, the interlocking controller 400 controls to connect a communication link to another electronic device to transmit the event information.

For another example, when an event occurs, the interlocking controller 400 determines whether to interlock event processing with another electronic device based on at least one of an event characteristic and state information of another electronic device (such as another electronic device 302 or 304). When it is determined to interlock event processing with another electronic device, the interlocking controller 400 transmits a state information request message to another electronic device through the communication unit 360 and determines state information of another electronic device. Thereafter, when another electronic device processes an event, the interlocking controller 400 controls to transmit event information to another electronic device through the communication unit 360. For example, when it is determined to interlock event processing with another electronic device, the interlocking controller 400 controls to connect a communication link to another electronic device to transmit the event information.

The event processor 420 controls to process an event that has occurred in the electronic device 300 or another electronic device to which a communication link is connected. In this case, by executing the event processing program 333 stored at the memory 330, the event processor 420 controls to process an event that has occurred in the electronic device 300 or another electronic device to which a communication link is connected. For example, when the interlocking controller 400 determines not to interlock event processing with another electronic device, the event processor 420 processes an event that has occurred in the electronic device 300.

For another example, when receiving event information from another electronic device through the communication unit 360, the event processor 420 processes an event that has occurred in another electronic device based on event information received from the another electronic device.

For another example, when receiving event information from another electronic device through the communication unit 360, the event processor 420 determines whether to interlock an event processing with another electronic device based on state information of the electronic device 300. When it is determined to interlock an event processing with another electronic device, the event processor 420 processes an event that has occurred in another electronic device based on event information received from the another electronic device.

For another example, when receiving event information from another electronic device through the communication unit 360, the event processor 420 displays event information received from the another electronic device in the display unit 350. Thereafter, when it is determined to interlock processing an event with another electronic device based on input information received through the input unit 340, the event processor 420 processes an event that has occurred in another electronic device based on event information received from the another electronic device.

The communication controller 410 controls to connect a communication link to another electronic device and to transmit and receive data through the communication unit 360. In this case, by executing the communication control program 331 stored at the memory 330, the communication controller 410 controls to connect a communication link to another electronic device and to transmit and receive data.

In the foregoing exemplary embodiment, the electronic device processes an event by interlocking with another electronic device using the processor 320.

In another exemplary embodiment, the electronic device includes a separate control module for processing an event by interlocking with another electronic device.

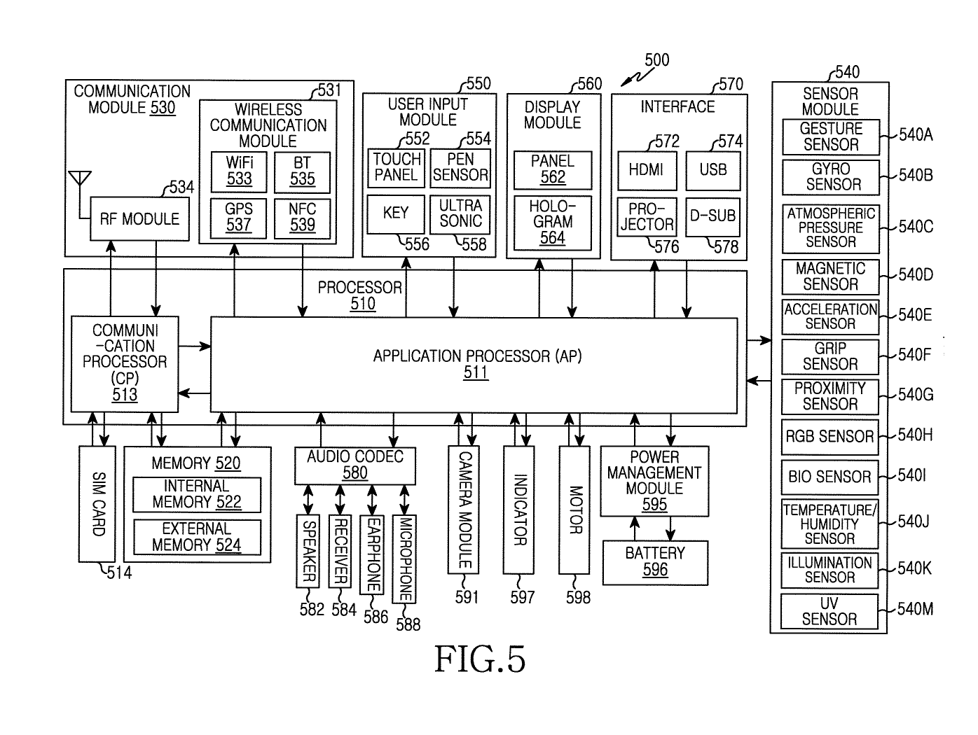

FIG. 5 is a block diagram illustrating an example configuration of an electronic device according to this disclosure.

Referring to FIG. 5, an electronic device 500 includes at least one processor 510, a Subscriber Identification Module (SIM) card 514, a memory 520, a communication module 530, a sensor module 540, a user input module 550, a display module 560, an interface 570, an audio codec 580, a camera module 591, a power management module 595, an indicator 597, and a motor 598.

The processor 510 includes at least one Application Processor (AP) 511 or at least one Communication Processor (CP) 513. For example, the AP 511 and the CP 513 is included within one processor 510, as shown in FIG. 5. For another example, the AP 511 and the CP 513 is included within different IC packages, respectively. In another example, the AP 511 and the CP 513 is included within an IC package. Additionally, the processor 510 further includes a Graphic Processing Unit (GPU) (not shown).

The AP 511 drives an operation system or an application program to control a plurality of hardware or software components connected to the AP 511 and performs various data processing and operations including multimedia data. For example, by executing a first application program stored at the memory 520, the AP 511 controls to transmit event information to another electronic device to which a communication link is connected through the communication module 530. For another example, by executing a second application program stored at the memory 520, the AP 511 controls to process an event that has occurred in the electronic device 500 or another electronic device to which a communication link is connected. Here, the AP 511 is implemented with a System on Chip (SoC).

The CP 513 performs a function of managing a data link for communication between the electronic device 500 and other electronic devices connected by a network and converting a communication protocol. Here, the CP 513 is implemented with a SoC.

The CP 513 performs at least a portion of a multimedia control function. For example, the CP 513 performs identification and authentication of the electronic device within a communication network using, a subscriber identification module (such as a SIM card 514). For another example, the CP 513 provides services such as audio dedicated communication, audiovisual communication, a text message, or packet data to a user.

Further, the CP 513 controls data transmission and reception of a Radio Frequency (RF) module 534.

The SIM card 514 is a card that implements a subscriber identity module and be inserted into a slot formed at a specific location of the electronic device 500. For example, the SIM card 514 includes intrinsic identification information (such as Integrated Circuit Card Identifier (ICCID)) or subscriber information (such as International Mobile Subscriber Identity (IMSI)).

The memory 520 includes an internal memory 522 or an external memory 524.

The internal memory 522 includes at least one of a volatile memory (such as a Dynamic RAM (DRAM), a Static RAM (SRAM), a Synchronous Dynamic RAM (SDRAM)), or a non-volatile memory (such as an One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, and a NOR flash memory). In this case, the internal memory 522 has a form of a Solid State Drive (SSD).

The AP 511 or the CP 513 loads and processes an instruction or data received from at least one of other elements or a non-volatile memory connected to each of the AP 511 and the CP 513 in a volatile memory. Further, the AP 511 or the CP 513 stores data received from at least one of other elements or generated by at least one of other elements at the non-volatile memory.

The external memory 524 includes a Compact Flash (CF), Secure Digital (SD), Micro Secure Digital (Micro-SD), Mini Secure Digital (Mini-SD), extreme Digital (xD), or memory stick.

The communication module 530 includes a wireless communication module 531 or an RF module 534.

The wireless communication module 531 includes a Wireless LAN (WiFi) module 533, a Bluetooth (BT) module 535, a Global Positioning System (GPS) 537, and a Near Field Communication (NFC) module 539. For example, the wireless communication module 531 provides a wireless communication function using a radio frequency. Additionally, the wireless communication module 531 includes a network interface (such as a LAN card) or a modem that connects the electronic device 500 to a network (such as Internet, a LAN, a WAN, a telecommunication network, a cellular network, a satellite network, or a POTS).

The RF module 534 performs transmission and reception of data, for example, transmission and reception of an RF signal or a called electronic signal. For example, the RF module 534 includes a transceiver, a Power Amp Module (PAM), a frequency filter, or a Low Noise Amplifier (LNA). Further, the RF module 534 further includes a component, for example, a conductor or a conductive wire that transmits and receives electromagnetic waves op free space in wireless communication.

The sensor module 540 measures a physical quantity or detects an operation state of en electronic device and convert measured or detected information to an electrical signal. For example, the sensor module 540 includes a gesture sensor 540A, a gyro sensor 540B, an atmospheric pressure sensor 540C, a magnetic sensor 540D, an acceleration sensor 540E, a grip sensor 540F, a proximity sensor 540G, a Red, Green, and Blue (RGB) sensor 540H, a bio sensor 540I, a temperature/humidity sensor 540J, an illumination sensor 540K, and a Ultra Violet (UV) sensor 540M. In this case, in addition to an element of FIG. 5, the sensor module 540 further includes an E-nose sensor (not shown), an electromyography sensor (EMG sensor) (not shown), an electroencephalogram sensor (EEG sensor) (not shown), an electrocardiogram sensor (ECG sensor) (not shown), or a fingerprint sensor (not shown). Further, the sensor module 540 further includes a control circuit that controls at least one sensor included therein.

The user input module 550 includes a touch panel 552, a pen sensor 554, a key 556, or an ultrasonic wave input device (ultrasonic) 558.

The touch panel 552 recognizes a touch input with at least one method of a capacitive, resistive, infrared ray, or ultrasonic wave method. When the touch panel 552 uses a capacitive touch method, the touch panel 552 recognizes a proximity touch as well as a direct touch. Additionally, the touch panel 552 further includes a controller (not shown). Further, in order to provide a haptic reaction to the user, the touch panel 552 further includes a tactile layer.

The pen sensor 554 is implemented using a separate recognition sheet similar to reception of a touch input of the user.

The key 556 includes a keypad or a touch key.

The ultrasonic wave input device 558 determines data by detecting a sound wave and perform wireless recognition.

Additionally, the electronic device 500 receives a user input from an external device (such as a network, a computer, or a server) through the communication module 530.

The display module 560 includes a panel 562 or a hologram 564.

The panel 562 includes a Liquid Crystal Display (LCD) or an Active-Matrix Organic Light-Emitting Diode (AMOLED). Further, the panel 562 is implemented with a flexible, transparent, or wearable method. In this case, the panel 562 and the touch panel 552 is formed in a module.

The hologram 564 shows a stereoscopic image in the air using interference of light.

Additionally, the display module 560 further includes a control circuit that controls the panel 562 or the hologram 564.

The interface 570 includes a High-Definition Multimedia Interface (HDMI) 572, an USB 574, a projector 576, and a D-subminiature (D-sub) 578. Additionally, the interface 570 is not shown and includes Secure Digital (SD)/Multi-Media Card (MMC), or Infrared Data Association (IrDA).

The audio codec 580 interactively converts a voice and an electric signal. For example, the audio codec 580 converts voice information input or output through a speaker 582, a receiver 584, an earphone 586, or a microphone 588.

The camera module 591 photographs an image and a moving picture. For example, the camera module 591 includes at least one image sensor (such as front surface lens or a rear surface lens), an Image Signal Processor (ISP) (not shown), or a flash LED (not shown).

The power management module 595 manages power of the electronic device 500. For example, the power management module 595 includes a Power Management Integrated Circuit (PMIC), a charger Integrated Circuit (charge IC), or a battery fuel gauge. The PMIC is mounted within an IC or a SoC semiconductor. The charge IC charges a battery 596 and prevents an overvoltage or an overcurrent from being injected from a charger. In this case, the charge IC includes a charge IC for at least one of a wire charge method or a wireless charge method. Here, the wireless charge method includes a magnetic resonance method, a magnetic induction method, or an electromagnetic wave method.

The battery gauge measures a residual quantity of the battery 596 and a voltage, a current, or a temperature while charging.

The battery 596 generates electricity to supply as power. In this case, the battery 596 is a rechargeable battery.

The indicator 597 displays state information of the electronic device 500 or some element (such as the AP 511) included in the electronic device 500. For example, the indicator 597 displays a booting state, a message state, or a charge state.

The motor 598 converts an electrical signal to a mechanical vibration.

Although not shown, the electronic device 500 includes a processing device (such as a Graphics Processing Unit (GPU)) for supporting a mobile TV. For example, the processing device for supporting a mobile TV processes media data according to a specification of Digital Multimedia Broadcasting (DMB), Digital Video Broadcasting (DVB), or media flow.

Names of the foregoing elements of the electronic device 500 according to an exemplary embodiment of the present disclosure can be changed according to a kind of the electronic device 500. Further, the electronic device 500 includes at least one of the elements, is formed in a form in which some elements are omitted, or further includes additional other elements according to a kind of the electronic device 500.

In the foregoing exemplary embodiment, in the electronic device 500, elements of the CP 513, the power management module 595, or the memory 520 are elements separate from the AP 511.

In another exemplary embodiment, in the electronic device 500, the AP 511 includes at least a portion of elements of the CP 513, the power management module 595, or the memory 520.

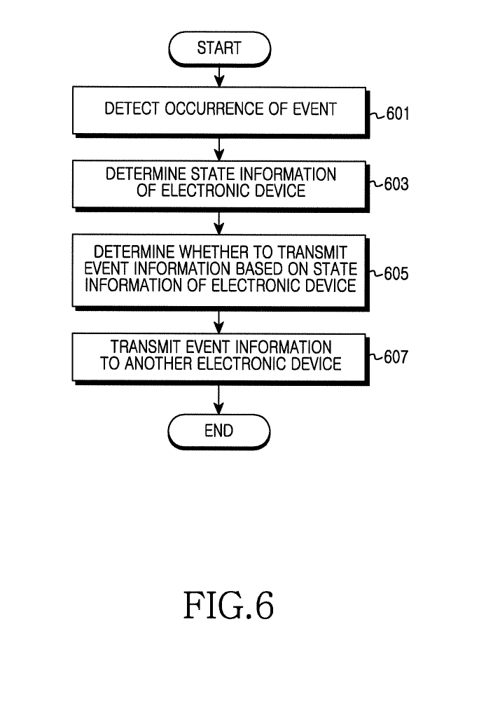

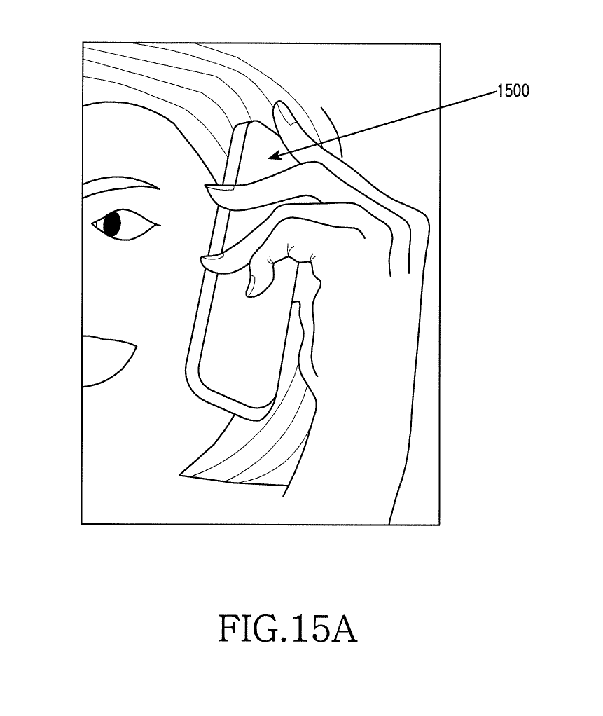

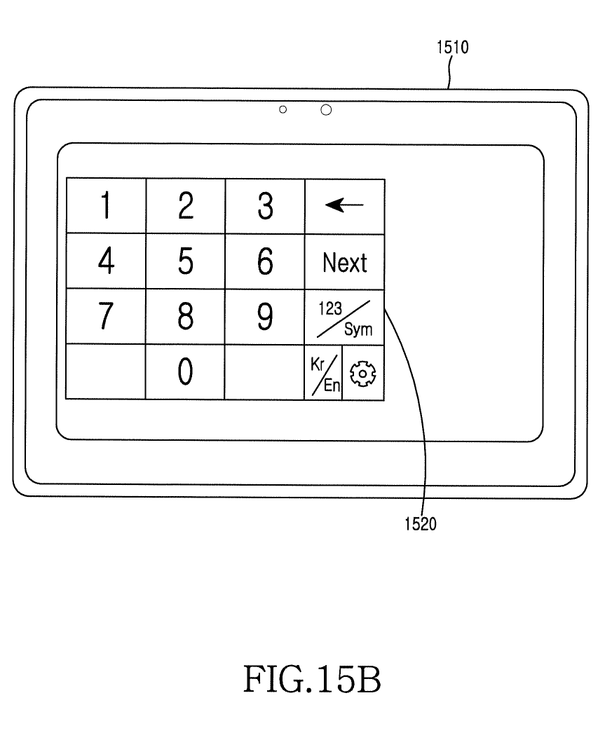

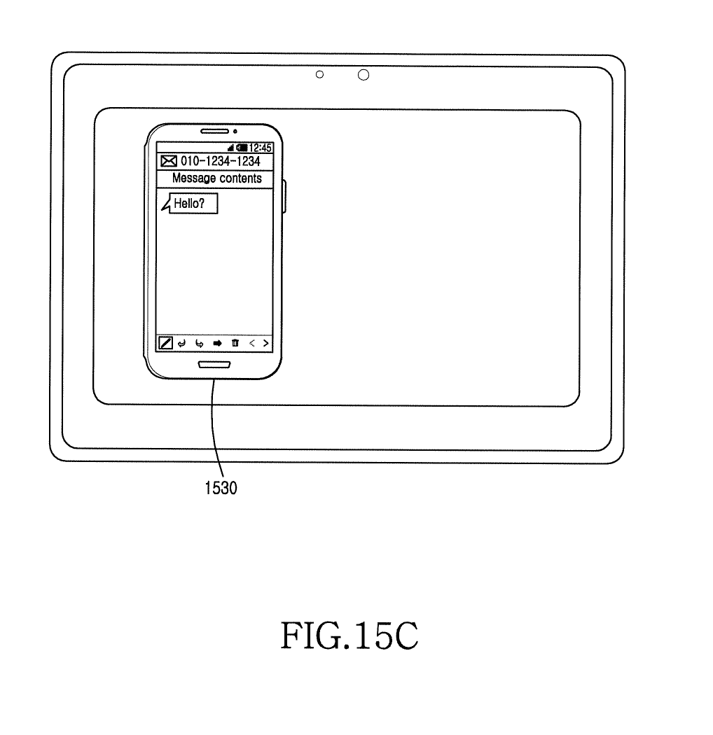

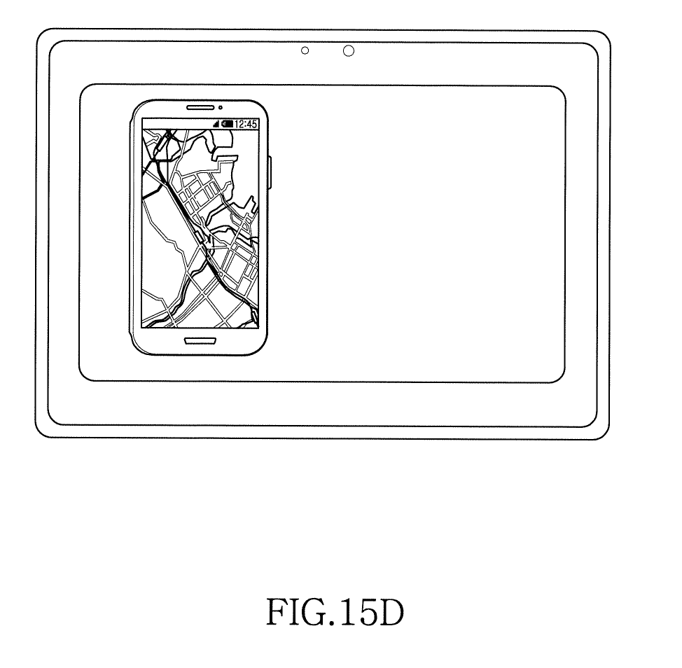

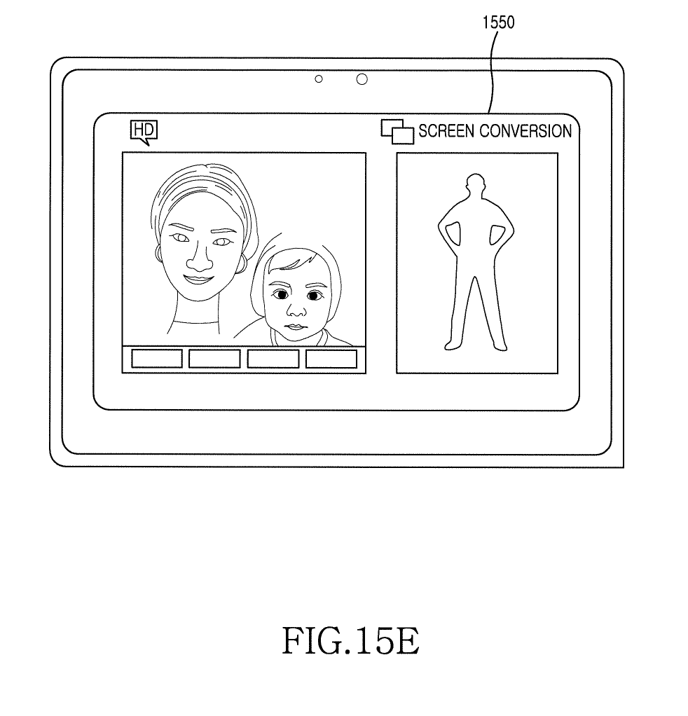

FIG. 6 is a flowchart illustrating an example procedure in which an electronic device transmits event information to another electronic device according to this disclosure. FIGS. 15A, 15B, 15C, 15D, and 15E are diagrams illustrating screen configurations in which an electronic device processes an event received from another electronic device according to this disclosure.

Referring to FIG. 6, the electronic device detects occurrence of event (601). For example, when the electronic device detects event occurrence, the electronic device determines a providing service. For example, the electronic device 1500 determines whether a keypad generation event occurs while providing a communication service, as shown in FIG. 15A. For another example, the electronic device 1500 determines whether a data reception event occurs in another electronic device while providing a communication service, as shown in FIG. 15A. For another example, the electronic device 1500 determines whether a message reception event occurs while providing a communication service, as shown in FIG. 15A.

When the electronic device detects event occurrence, the electronic device determines state information thereof (603). For example, the electronic device determines a user movement using sensing data acquired through the sensor module 370. For another example, the electronic device determines a battery residual quantity. For another example, the electronic device determines a processing load of the processor 320.

The electronic device determines whether to transmit event information based on state information thereof (605). For example, when a user determines the display unit 350 based on state information of an electronic device or when it is difficult to control the electronic device, the electronic device determines to transmit event information to another electronic device. For another example, when a battery residual quantity of the electronic device is a reference residual quantity or less, the electronic device determines to transmit event information to another electronic device. For another example, when a processing load of the processor 320 is a reference load or more, the electronic device determines to transmit event information to another electronic device.

When it is determined to transmit event information to another electronic device, the electronic device transmits event information to another electronic device to which a communication link is set (607).

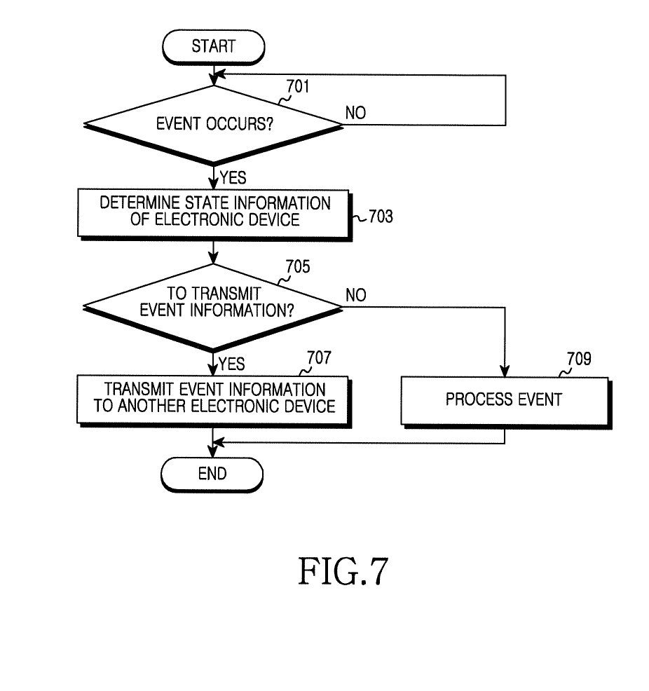

FIG. 7 is a flowchart illustrating an example procedure in which an electronic device transmits event information to another electronic device based on state information of the electronic device according to this disclosure.

Referring to FIG. 7, the electronic device detects whether an event occurs (701). For example, when the electronic device detects event occurrence, the electronic device determines a providing service. For example, the electronic device 1500 determines whether a keypad generation event occurs while providing a communication service, as shown in FIG. 15A. For another example, the electronic device 1500 determines whether a data reception event occurs in another electronic device while providing a communication service, as shown in FIG. 15A. For another example, the electronic device 1500 determines whether a message reception event occurs while providing a communication service, as shown in FIG. 15A. For another example, when the electronic device detects event occurrence, the electronic device determines whether a communication service requiring a keypad, such as an ARS communication service is provided. For another example, the electronic device determines whether a photographing event occurs while providing a camera service. For another example, the electronic device determines whether a user's location change event occurs while performing audiovisual communication.

When the electronic device detects event occurrence, the electronic device determines state information thereof (703). For example, the electronic device determines at least one of a user movement, a battery residual quantity, and a processing load of the processor 320 using sensing data acquired through the sensor module 370.

The electronic device determines whether to transmit event information based on state information thereof (705). For example, when a user determines the display unit 350 based on state information of an electronic device or when it is difficult to control the electronic device, the electronic device determines to transmit event information to another electronic device. For another example, when a battery residual quantity of the electronic device is a reference residual quantity or less, the electronic device determines to transmit event information to another electronic device. For another example, when a processing load of the processor 320 is a reference load or more, the electronic device determines to transmit event information to another electronic device.

If event information can be transmitted to another electronic device, the electronic device transmits event information to another electronic device to which a communication link is set (707). For example, the electronic device transmits event occurrence information to another electronic device. For another example, the electronic device transmits control information for processing an event to another electronic device.

If event information cannot be transmitted to another electronic device at step 705, the electronic device processes the event (709). For example, when a keypad generation event occurs while providing a communication service, the electronic device displays a virtual keypad in the display unit 350. For another example, when receiving location data from another electronic device while providing a communication service, the electronic device displays location data received from the another electronic device in the display unit 350. For another example, when receiving a message while providing a communication service, the electronic device displays message receiving information in the display unit 350 and generate a message reception notification sound. For another example, when detecting a photographing event while providing a camera service, the electronic device displays a photograph image in the display unit 350.

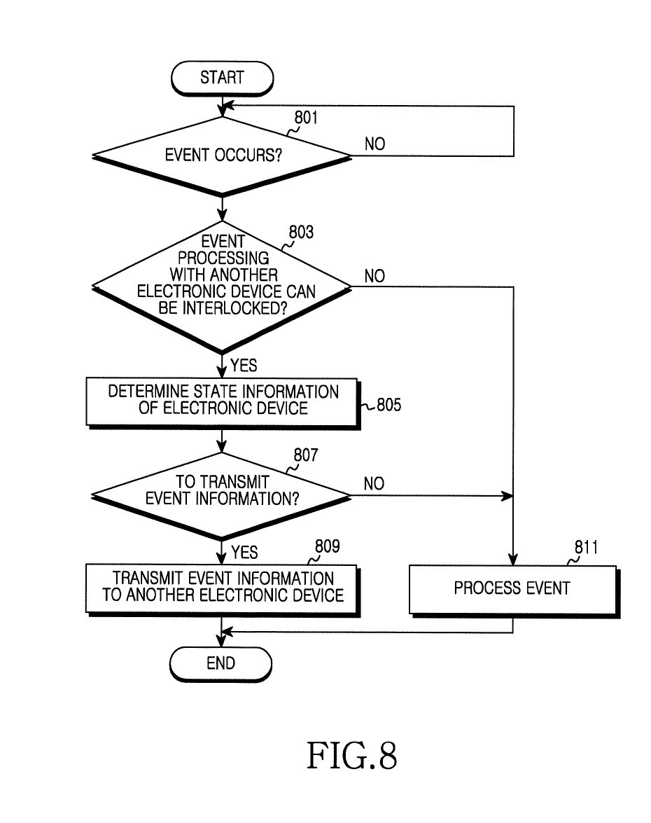

FIG. 8 is a flowchart illustrating an example procedure in which an electronic device transmits event information to another electronic device based on state information of the electronic device according to this disclosure.

Referring to FIG. 8, the electronic device detects whether an event occurs (801). For example, when the electronic device detects event occurrence, the electronic device determines a providing service. For example, the electronic device 1500 determines whether a keypad generation event occurs while providing a communication service, as shown in FIG. 15A. For another example, the electronic device 1500 determines whether a data reception event occurs in another electronic device while providing a communication service, as shown in FIG. 15A. For another example, the electronic device 1500 determines whether a message reception event occurs while providing a communication service, as shown in FIG. 15A. For another example, when the electronic device detects event occurrence, the electronic device determines whether a communication service requiring a keypad, such as an ARS communication service is provided. For another example, the electronic device determines whether a photographing event occurs while providing a camera service. For another example, the electronic device determines whether a user's location is changed while performing audiovisual communication.

If an event occurs, the electronic device determines whether to interlock an event processing with another electronic device (803). For example, the electronic device determines whether to interlock an event processing with another electronic device based on an event characteristic. Here, the event characteristic includes at least one of an event kind and a kind of an application program while executing in the electronic device when an event occurs. For another example, the electronic device determines whether another electronic device to which a communication link that interlocks an event processing is connected exists. If another electronic device to which a communication link is connected does not exist, the electronic device determines not to interlock an event processing with another electronic device.

If an event processing with another electronic device cannot be interlocked, the electronic device processes the event (811). For example, when a keypad generation event occurs while providing a communication service, the electronic device displays a virtual keypad in the display unit 350. For another example, when receiving location data from another electronic device while providing a communication service, the electronic device displays location data received from the another electronic device in the display unit 350. For another example, when receiving a message while providing a communication service, the electronic device displays message receiving information in the display unit 350 and generate a message reception notification sound. For another example, when detecting a photographing event while providing a camera service, the electronic device displays a photograph image in the display unit 350.

If an event processing with another electronic device is interlocked at step 803, the electronic device determines state information thereof (805). For example, the electronic device determines at least one of a user movement, a battery residual quantity, and a processing load of the processor 320 using sensing data acquired through the sensor module 370.

The electronic device determines whether to transmit event information based on state information thereof (807). For example, when a user determines the display unit 350 based on state information of the electronic device or when it is difficult to control the electronic device, the electronic device determines to transmit event information to another electronic device. For another example, when a battery residual quantity of the electronic device is a reference residual quantity or less, the electronic device determines to transmit event information to another electronic device. For another example, when a processing load of the processor 320 is a reference load or more, the electronic device determines to transmit event information to another electronic device.

If event information is transmitted to another electronic device, the electronic device transmits event information to another electronic device to which a communication link is set (809). For example, the electronic device transmits event occurrence information to another electronic device. For another example, the electronic device transmits control information for processing an event to another electronic device.

If event information cannot be transmitted to another electronic device at step 807, the electronic device processes the event (811). For example, when a keypad generation event occurs while providing a communication service, the electronic device displays a virtual keypad in the display unit 350. For another example, when receiving location data from another electronic device while providing a communication service, the electronic device displays location data received from the another electronic device in the display unit 350. For another example, when receiving a message while providing a communication service, the electronic device displays message receiving information in the display unit 350 and generate a message reception notification sound. For another example, when detecting a photographing event while providing a camera service, the electronic device displays a photograph image in the display unit 350.

In the foregoing exemplary embodiment, the electronic device determines to interlock an event processing with another electronic device based on at least one of an event characteristic and information on whether another electronic device to which a communication link is connected exists and determine whether to interlock an event processing with another electronic device based on state information of the electronic device. In this case, a process of determining to interlock an event processing with another electronic device based on at least one of an event characteristic and information on whether another electronic device to which a communication link is connected exists and a process of determining whether to interlock an event processing with another electronic device based on state information of the electronic device operates in parallel.

In the foregoing exemplary embodiment, the electronic device determines not to interlock an event processing with another electronic device in which another electronic device to which a communication link is connected does not exist.

In another exemplary embodiment, after it is determined to interlock an event with another electronic device, the electronic device sets a communication link to another electronic device for interlocking an event.

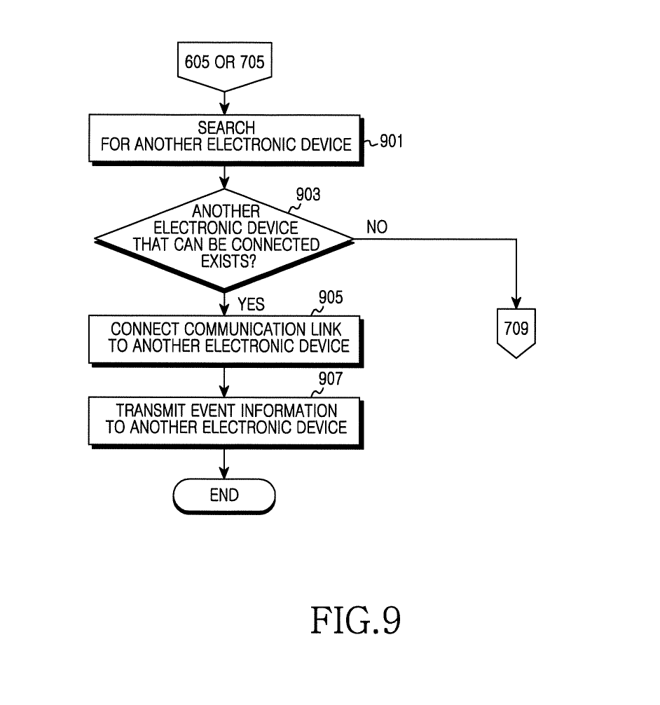

FIG. 9 is a flowchart illustrating an example procedure in which an electronic device sets a communication link to another electronic device for interlocking event information according to this disclosure.

Referring to FIG. 9, when it is determined to transmit event information to another electronic device at step 605 of FIG. 6 or at step 705 of FIG. 7, the electronic device searches for another electronic device to which a communication link is set (901).

The electronic device determines whether another electronic device to connect a communication link exists according to a search result of another electronic device (903).

If another electronic device to connect a communication link does not exist, it is recognized that the electronic device cannot interlock an event with another electronic device. Accordingly, the electronic device processes the event at step 709 of FIG. 7.

If another electronic device to connect a communication link exists at step 903, the electronic device connects a communication link to the found another electronic device (905). Thereafter, the electronic device performs authentication with another electronic device to which a communication link is connected. When authentication with another electronic device is failed, the electronic device recognizes that a communication link connection to another electronic device is failed.

When a communication link to another electronic device is connected, the electronic device transmits event information to another electronic device to connect a communication link (907). For example, the electronic device transmits event occurrence information to another electronic device. For another example, the electronic device transmits control information for processing an event to another electronic device.

As described above, in order to interlock and process an event with another electronic device, the electronic device transmits event information to another electronic device to which a communication link is connected. For example, when a plurality of other electronic devices to which a communication link is connected exist, the electronic device determines at least one another electronic device to transmit event information in consideration of at least one of sound beamforming, a user's location information, and a gap with another electronic device. Here, a gap with another electronic device is determined based on at least one of location information or signal intensity of another electronic device.

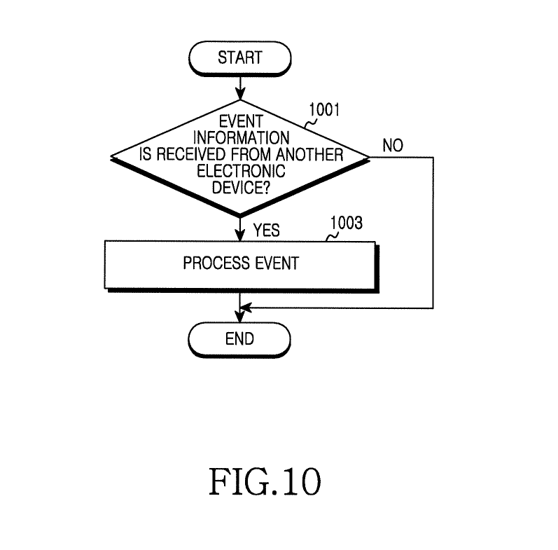

FIG. 10 is a flowchart illustrating an example procedure in which an electronic device processes an event received from another electronic device according to this disclosure.

Referring to FIG. 10, the electronic device determines whether event information is received from another electronic device to which a communication link is connected (1001).

If event information is received from another electronic device, the electronic device processes an event that has occurred in another electronic device according to event information received from the another electronic device (1003). For example, when receiving keypad generation event information from the another electronic device, an electronic device 1510 displays a virtual keypad 1520 in the display unit 350, as shown in FIG. 15B. For another example, when receiving message receiving information from the another electronic device, the electronic device displays message receiving information 1530 in the display unit 350, as shown FIG. 15C. In this case, the electronic device generates a message reception notification sound. For another example, when receiving location data reception information from the another electronic device, the electronic device displays location data received from the another electronic device in the display unit 350, as shown in FIG. 15D. For another example, when receiving user location change information from another electronic device while servicing audiovisual communication, the electronic device displays an audiovisual communication screen 1550 of another electronic device in the display unit 350, as shown in FIG. 15E. In this case, as a user approaches the electronic device while performing audiovisual communication, when the user cannot determine the display unit 350, another electronic device transmits user location change information to the electronic device. Accordingly, the electronic device displays an image of another electronic device displayed in an audiovisual communication service as a preset basic image. For another example, when receiving photographing event information from another electronic device while providing a camera service, the electronic device displays an image photographed in another electronic device in the display unit 350.

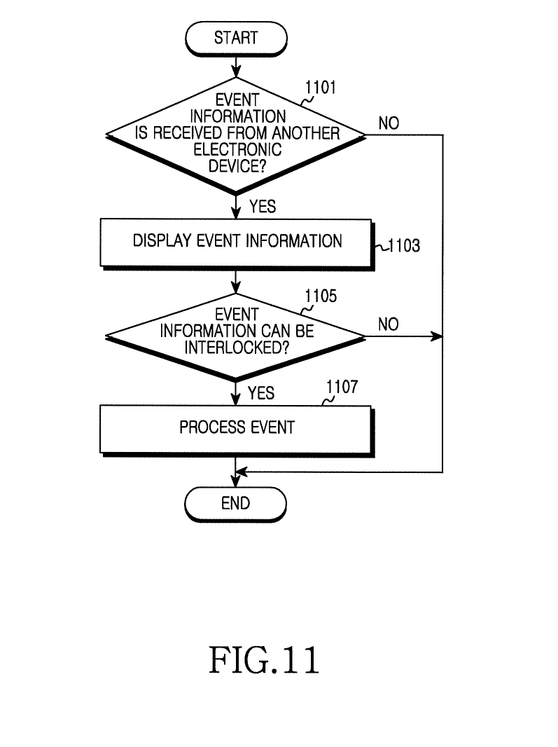

FIG. 11 is a flowchart illustrating an example procedure in which an electronic device processes an event received from another electronic device according to this disclosure.

Referring to FIG. 11, the electronic device determines whether event information is received from another electronic device to which a communication link is connected (1101).

If event information is received from another electronic device, the electronic device displays the event information received from the other electronic device in the display unit 350 (1103).

The electronic device determines whether to interlock the event processing with another electronic device based on input information received through the input unit 340 (1105).

If the event processing with another electronic device cannot be interlocked, the electronic device terminates the present algorithm In this case, the electronic device transmits event processing limitation information to another electronic device.

If the event processing with another electronic device is interlocked, the electronic device processes the event that has occurred in another electronic device based on the event information received from the other electronic device (1107).

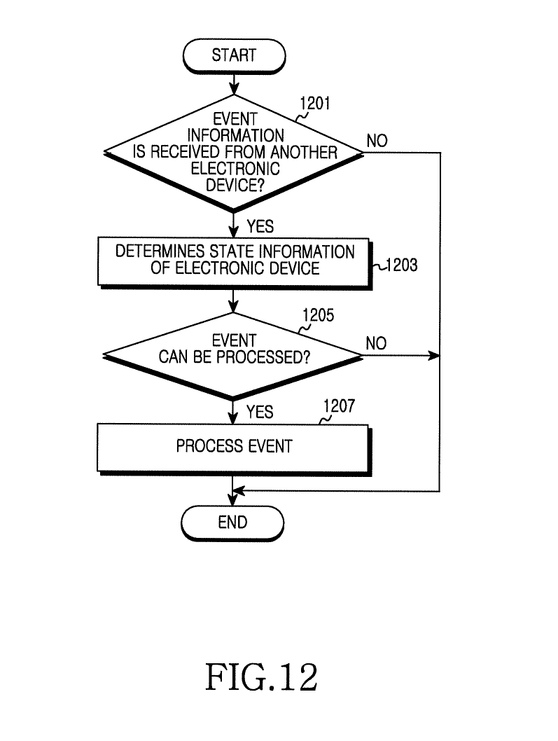

FIG. 12 is a flowchart illustrating an example procedure in which an electronic device processes an event received from another electronic device based on state information of the electronic device according to this disclosure.

Referring to FIG. 12, the electronic device determines whether event information is received from another electronic device to which a communication link is connected (1201).

If event information is received from another electronic device, the electronic device determines state information thereof (1203). For example, the electronic device determines at least one of a user movement, a battery residual quantity, and a processing load of the processor 320 using sensing data acquired through the sensor module 370.

After the electronic device determines state information, the electronic device determines whether an event received from another electronic device can be processed (1205).

If an event received from another electronic device cannot be processed, the electronic device terminates the present algorithm. In this case, the electronic device transmits event processing limitation information to another electronic device.

If an event received from another electronic device can be processed, the electronic device processes the event that has occurred in another electronic device according to event information received from the another electronic device (1207).

In the foregoing exemplary embodiment, the electronic device determines whether to process an event by interlocking with another electronic device based on at least one of an event characteristic and state information of the electronic device.

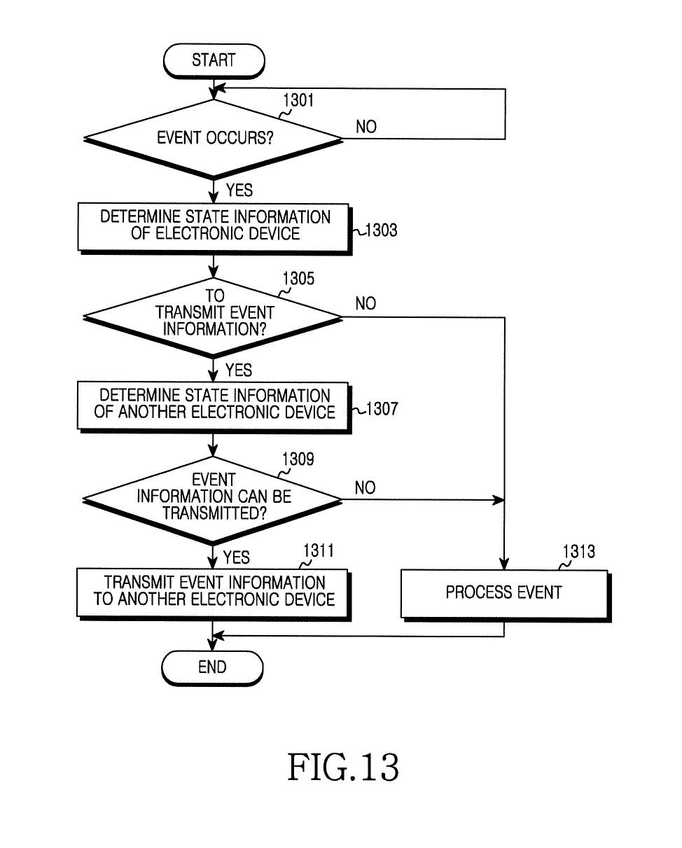

In another exemplary embodiment, the electronic device determines whether to process an event by interlocking with another electronic device based on state information of the another electronic device, as shown in FIG. 13.

FIG. 13 is a flowchart illustrating an example procedure in which an electronic device transmits event information to another electronic device based on state information of the another electronic device according to this disclosure.

Referring to FIG. 13, the electronic device detects whether an event occurs (1301). In this case, the electronic device detects whether an event occurs while providing a specific service.

If an event occurs, the electronic device determines state information thereof (1303). For example, the electronic device determines at least one of a user movement, a battery residual quantity, and a processing load of the processor 320 using sensing data acquired through the sensor module 370.

When state information of the electronic device is determined, the electronic device determines whether to transmit event information to another electronic device based on state information thereof (1305). For example, the electronic device determines whether to interlock an event processing with another electronic device based on state information of the electronic device.

If event information cannot be transmitted to another electronic device, the electronic device processes the event (1313).

If event information can be transmitted to another electronic device at step 1305, the electronic device determines state information of another electronic device (1307). For example, the electronic device transmits a state information request signal to another electronic device to which a communication link is connected. The electronic device determines state information of another electronic device using a response signal to the state information request signal received from the other electronic device. For another example, when it is determined to transmit event information to another electronic device, the electronic device connects a communication link to adjacent another electronic device and transmit a state information request signal to another electronic device. The electronic device determines state information of another electronic device using a response signal to a state information request signal received from the other electronic device.

Thereafter, the electronic device determines whether event information can be transmitted to another electronic device based on state information of the other electronic device (1309). For example, the electronic device determines whether to interlock an event processing with another electronic device based on state information of the another electronic device.

If event information can be transmitted to another electronic device, the electronic device transmits the event information to another electronic device to which a communication link is set (1311). For example, the electronic device transmits event occurrence information to another electronic device. For another example, the electronic device transmits control information for processing an event to another electronic device.

If event information cannot be transmitted to another electronic device, the electronic device processes the event (1313).

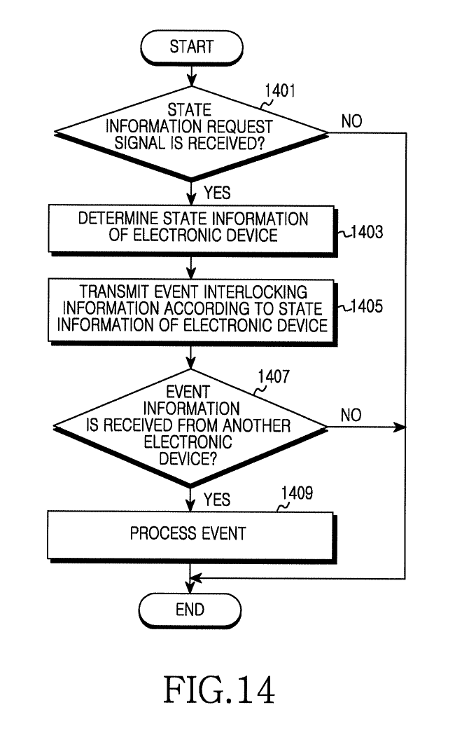

FIG. 14 is a flowchart illustrating an example procedure in which an electronic device processes an event received from another electronic device based on state information of the electronic device according to this disclosure.

Referring to FIG. 14, the electronic device determines whether a state information request signal is received from another electronic device to which a communication link is connected (1401).

If a state information request signal is received from another electronic device, the electronic device determines state information thereof (1403). For example, the electronic device determines at least one of a user movement, a battery residual quantity, and a processing load of the processor 320 using sensing data acquired through the sensor module 370.

After the electronic device determines state information thereof, the electronic device transmits event interlocking information according to state information thereof to another electronic device (1405). For example, the electronic device transmits the state information of the electronic device determined at step 1403 to another electronic device. For another example, the electronic device determines whether an event received from the other electronic device can be processed based on state the information of the electronic device determined at step 1403. Thereafter, the electronic device transmits information on whether an event received from another electronic device can be processed to another electronic device.

Thereafter, the electronic device determines whether event information is received from another electronic device to which a communication link is connected (1407).

If event information is received from another electronic device, the electronic device processes the event that has occurred in another electronic device according to event information received from the other electronic device (1409).

According to various exemplary embodiments of the present disclosure, as an electronic device processes an event by interlocking with another electronic device to which a communication link is connected based on at least one of state information of another electronic device, an event characteristic, and state information of the electronic device, user convenience for processing an event using the another electronic device can be improved.

While the present disclosure has been particularly shown and described with reference to exemplary embodiments thereof, it will be understood by those skilled in the art that various changes in form and details may be made therein without departing from the spirit and scope of the present disclosure as defined by the appended claims. Therefore, the scope of the present disclosure is not limited to the described exemplary embodiment but should be determined by the appended claims and their equivalents.

What is claimed is:

1. A method of operating an electronic device, the method comprising:
detecting an occurrence of an event;
determining state information of the electronic device;
determining whether to interlock event processing with at least one second electronic device based on the state information of the electronic device; and
transmitting event information to the at least one second electronic device in response to determining to interlock event processing with the at least one second electronic device.

2. The method of claim 1, wherein detecting the occurrence of the event comprises detecting at least one of a keypad generation event, a data reception event, and a message reception event while providing a communication service.

3. The method of claim 1, wherein detecting the occurrence of the event comprises detecting an occurrence of a photographing event while providing a camera service.

4. The method of claim 1, wherein determining the state information comprises determining at least one of user movement information, a battery residual quantity, and a processing load of the electronic device.

5. The method of claim 4, wherein determining the state information comprises estimating user movement information of the electronic device using at least one of a gesture sensor, a gyro sensor, an acceleration sensor, a grip sensor, a proximity sensor, and an illumination sensor.

6. The method of claim 1, further comprising determining an event characteristic before the determining of whether to interlock event processing, wherein the event characteristic comprises at least one of a kind of the detected event and a kind of an application program while executing in the electronic device, when the event occurs.

7. The method of claim 6, wherein determining whether to interlock event processing comprises determining whether to interlock the event processing with at least one second electronic device based on the event characteristic and the state information of the electronic device.

8. The method of claim 1, wherein transmitting the event information comprises:
setting a communication link to at least one second electronic device in response to determining to interlock event processing with the at least one second electronic device; and
transmitting event information to at least one second electronic device to which a communication link is set.

9. The method of claim 1, further comprising:
determining state information of the at least one second electronic device in response to determining to interlock event processing with the at least one second electronic device;
determining for a second time whether to interlock the event processing with the at least one second electronic device based on state information of the at least one second electronic device; and
transmitting event information to the at least one second electronic device in response to determining to interlock event processing with the at least one second electronic device.

10. The method of claim 1, wherein transmitting the event information comprises transmitting event occurrence information or control information for processing the event to the at least one second electronic device.

11. An electronic device, comprising:
a communication unit;
a sensor module; and
a processor configured to determine whether to interlock the event processing with at least one second electronic device based on the determined state information of the electronic device using the sensor module in response to an event occurrence, and transmit event information to the at least one second electronic device through the communication unit in response to determining to interlock event processing with the at least one second electronic device.

12. The electronic device of claim 11, wherein the processor is configured to detect at least one of a keypad generation event, a data reception event, and a message reception event while providing a communication service.

13. The electronic device of claim 11, wherein the processor is configured to detect an occurrence of a photographing event while providing a camera service.

14. The electronic device of claim 11, wherein the processor is configured to determine at least one of user movement information, a battery residual quantity, and a processing load of the electronic device.

15. The electronic device of claim 11, wherein the sensor module comprises at least one of a gesture sensor, a gyro sensor, an acceleration sensor, a grip sensor, a proximity sensor, and an illumination sensor, and
the processor is configured to estimate user movement information of the electronic device using the sensor module.

16. The electronic device of claim 11, wherein the processor is configured to determine an event characteristic and determines whether to interlock the event processing with at least one second electronic device based on the event characteristic and state information of the electronic device.

17. The electronic device of claim 16, wherein the event characteristic comprises at least one of a kind of the detected event and a kind of an application program while executing in the electronic device, when an event occurs.

18. The electronic device of claim 11, wherein the processor is configured to set a communication link to at least one second electronic device through the communication unit in response to determining to interlock event processing with the at least one second electronic device.

19. The electronic device of claim 11, wherein the processor is configured to determine state information of the at least one second electronic device in response to determining to interlock event processing with the at least one second electronic device, determines for a second time whether to interlock the event processing with the at least one second electronic device based on state information of the at least one second electronic device, and transmit event information to the at least one second electronic device through the communication unit in response to determining to interlock event processing with the at least one second electronic device.

20. The electronic device of claim 11, wherein the processor is configured to transmit event occurrence information or control information for processing the event through the communication unit to the at least one second electronic device.
